(19) United States
(12) Patent Application Publication
(10) Pub. No.: US 2014/0114815 A1
(43) Pub. Date: Apr. 24, 2014

(54) System And Method For Managing And Using A Third Party Subsidy Account

(71) Applicants: Tracy Dangott, Chicago, IL (US); Christopher Ciavarro, Chicago, IL (US); Trent Hartsfield, Riverview, FL (US); Kevin Kidd, Tampa, FL (US); Christopher Paton, Northbrook, IL (US)

(72) Inventors: Tracy Dangott, Chicago, IL (US); Christopher Ciavarro, Chicago, IL (US); Trent Hartsfield, Riverview, FL (US); Kevin Kidd, Tampa, FL (US); Christopher Paton, Northbrook, IL (US)

(73) Assignee: JPMORGAN CHASE BANK, N.A., New York, NY (US)

(21) Appl. No.: 13/115,449

(22) Filed: May 25, 2011

(51) Int. Cl. G07F 19/00; G06Q 40/00

(52) U.S. Cl. 705/30; 705/39

(57) ABSTRACT

Systems and methods for using a third party subsidy account are disclosed. A method may include (1) using a computer processor, enrolling a subsidy recipient in a subsidy program; (2) using the computer processor, funding a subsidy account for the subsidy recipient with subsidy funds having a first subsidy expiration; (3) using the computer processor, de-funding the subsidy account at the subsidy expiration; and (4) using the computer processor, funding the subsidy account with subsidy funds having a second subsidy expiration. The method may further include (5) using the computer processor, monitoring a use of the subsidy funds; and (6) using the computer processor, providing a notification regarding the subsidy funds to the subsidy recipient. The notification may include a balance of the subsidy funds, an expiration for the subsidy funds, etc. The notification may be a text-based notification, a graphical notification, an audible notification, etc.

### BACKGROUND OF THE INVENTION

1. Field of the Invention

The present invention generally relates to subsidies, and, more particularly, to a system and method for using a third party subsidy account.

2. Description of the Related Art

Some employers subsidize certain benefits for their employees. For example, some employers subsidize employee commuting, health insurance, child care, and even meals. Certain tax benefits exist for employers that provide these subsidies.

### SUMMARY OF THE INVENTION

Systems and methods for using a third party subsidy account are disclosed. According to one embodiment, a method includes (1) using a computer processor, enrolling a subsidy recipient in a subsidy program; (2) using the computer processor, funding a subsidy account for the subsidy recipient with subsidy funds having a first subsidy expiration; (3) using the computer processor, de-funding the subsidy account at the subsidy expiration; and (4) using the computer processor, funding the subsidy account with subsidy funds having a second subsidy expiration.

The step of de-funding the subsidy account may include transferring subsidy funds remaining in the subsidy account to an account of the subsidy provider.

According to another embodiment, a method of using a third party subsidy account includes (1) using a computer processor, enrolling a subsidy recipient in a subsidy program for a subsidy amount; (2) using the computer processor, funding a subsidy account for the subsidy recipient with a first funding, the first funding equaling the subsidy amount and having a first expiration; (3) using the computer processor, at the first expiration, determining an amount of subsidy funds remaining in the subsidy account; and (4) using the computer processor, funding the subsidy account with a second funding, the second funding being a difference between the subsidy amount and the amount of subsidy funds remaining, the total funds in the subsidy account having a second expiration.

The methods may further include the steps of using the computer processor, monitoring a use of the subsidy funds; and using the computer processor, providing a notification regarding the subsidy funds to the subsidy recipient. The notification may include a balance of the subsidy funds, an expiration for the subsidy funds, etc. The notification may be a text-based notification, a graphical notification, an audible notification, etc.

The use of the subsidy accounts may also be limited or restricted. This may be by using merchant category codes, merchant identifiers, geographic restrictions, time/date restrictions, value restrictions, etc.

The subsidy may be a dollar amount, a number of an item, etc. The subsidy expiration may be based on a value of the subsidy, a time period, etc. The subsidy account may be funded with funds from a subsidy provider.

According to another embodiment, a method for providing information regarding a status of a third party subsidy account includes (1) using a computer processor, monitoring a use of the subsidy funds in a subsidy account by a subsidy recipient, the subsidy funds having a funding amount and an expiration; and (2) using a display, displaying a status of the subsidy funds, the status comprising an indication of the subsidy funds remaining and the expiration.

The subsidy may be a dollar amount, a number of an item, etc. The subsidy expiration may be based on a value of the subsidy, a time period, etc.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is an illustration of a system for managing and using a third party subsidy account according to one embodiment;

FIG. 2 is a flowchart illustrating a method for issuing a third party subsidy account according to one embodiment;

FIG. 3 is a flowchart illustrating a method for using a third party subsidy account according to one embodiment;

FIG. 4 is a flowchart illustrating a method for managing a third party subsidy account according to one embodiment.

### DETAILED DESCRIPTION OF PREFERRED EMBODIMENTS

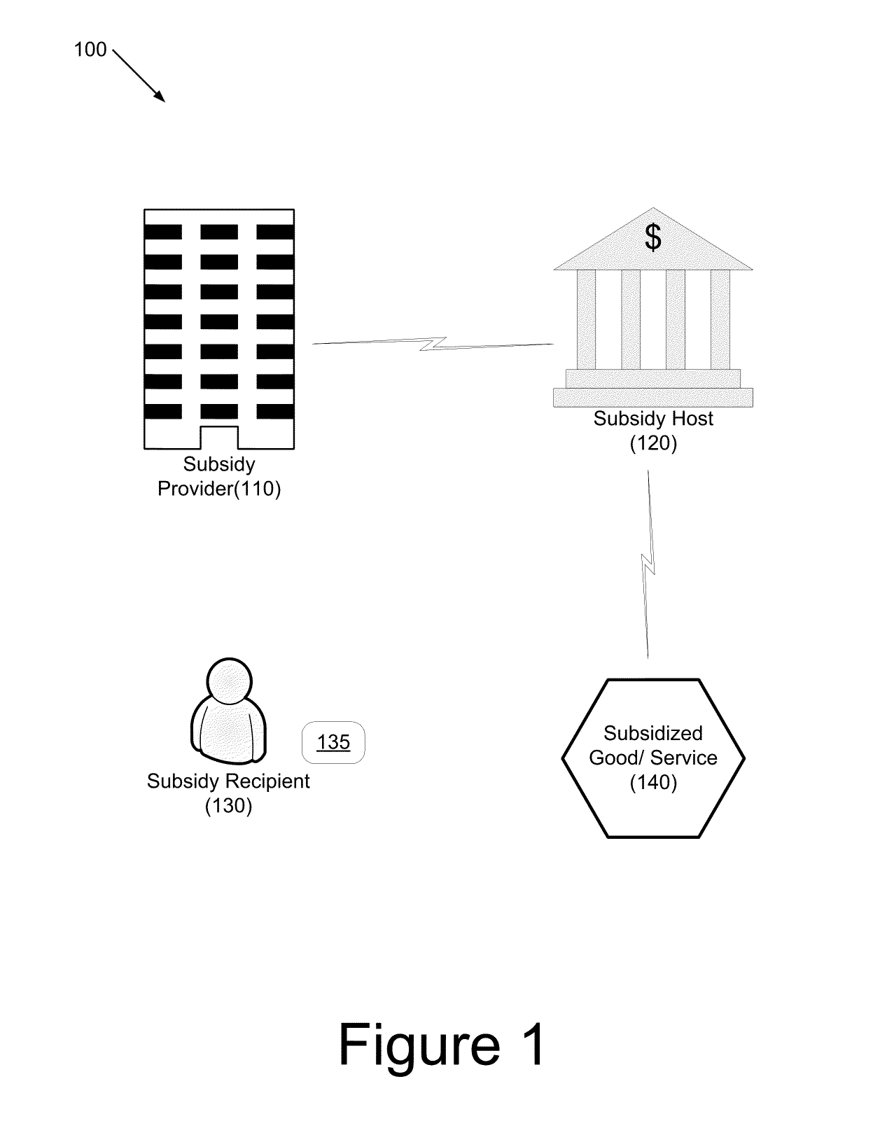

Several embodiments of the present invention and their advantages may be understood by referring to FIGS. 1-4, wherein like reference numerals refer to like elements.

The following disclosures are related to the present invention: U.S. patent application Ser. No. 11/942,211, entitled “System And Method For Granting Access To A Restricted Access Area Using An Approved List”; U.S. patent application Ser. No. 12/966,287, entitled “System And Method For Granting Access To A Restricted Access Area Using An Approved List”; U.S. patent application Ser. No. 12/823,731, entitled “System And Method For Issuance, Use, And Replacement Of Multi-Purpose Devices”; U.S. patent application Ser. No. 12/823,764 , entitled “System And Method Of Using Multi-Purpose Devices With Multiple Systems”; U.S. Pat. No. 7,660,763, entitled “Customer activated multi-value (CAM) card”; and U.S. patent application Ser. No. 12/767,525, entitled “Targeted Benefit Account”. The disclosures of these patents and applications, and any continuations or continuations-in-part are specifically incorporated by reference herein.

Although the invention is primarily described below in the context of a commuting subsidy provided by an employer (an example of a subsidy provider) for an employee (an example of a subsidy recipient), it should be recognized that the invention is not so limited. The invention has broad applicability to subsidies that may be provided by non-employers (e.g., a government agency, a school district, a county, non-governmental organizations, etc.) to individuals.

The present invention has applicability to a broad range of subsidies and/or pre-tax accounts and/or benefits, including, for example, parking, healthcare, meals (e.g., school lunch program, woman-infant-child, etc.), telecommunications (e.g., telephone fees, Internet service provider fees, mobile telephone fees, etc.), utilities (e.g., electric, gas, etc.), child care/babysitting, foster care, elder care, travel (e.g., hotel fees, etc.), expense accounts, tuition, financial aid, housing, rent, utility, etc.

Referring to FIG. 1, a system for managing and using a third party subsidy account according to one embodiment is illustrated. System 100 may include subsidy provider 110, subsidy host 120, subsidy recipient 130, and subsidized good/service 140.

Subsidy provider 110 may be any entity or organization that provides a subsidy or pre-tax benefit to subsidy recipients. Examples of a subsidy provider include an employer (a corporation, a partnership, etc.), a government agency (federal, state, county, etc.), a non-governmental organization, a school district, a municipality, a political organization, etc. The employer may also be a for-profit organization or a not-for-profit organization.

Subsidy host 120 may be any suitable entity or organization that manages financial accounts. In one embodiment, host 120 may be a financial institution (e.g., a bank, a credit card issuer, a credit union, a financial services company), an intermediary for any of the above, a data processor, a third party provider, etc.

Subsidy recipient 130 may be an individual, a group of individuals, or an organization that receives a subsidy from subsidy provider 110. In one embodiment, subsidy recipient 130 may be an employee (e.g., a paid employee, a temporary employee, an equity partner, a volunteer, an individual on leave, etc.). In another embodiment, subsidy recipient 130 may be a resident of a country, state, county, or municipality. In another embodiment, subsidy recipient 130 may be a student, an elderly person, etc.

Subsidy recipient 130 may be provided with financial instrument 135. Financial instrument 135 may be any suitable transaction instrument, including, for example, a credit card, a stored value card, a pre-paid card, an on-card stored value account, a debit card, a private label card, a smart card, an electronic purse, a card, a fob, a sticker, a token, an electronic device, a memory card, a cell phone, a PDA, an account (including on-line accounts), etc. In one embodiment, the financial instrument may be represented by a bar code (two and three dimensional), QR codes, or any other machine-readable code.

In one embodiment, financial instrument 135 may have a credit card form factor and may include, for example, a magnetic stripe, electronic contacts, an integrated circuit, etc. In another embodiment, financial instrument 135 may not require the presence of physical media. For example, financial instrument 135 may be a virtual financial instrument.

Financial instrument 135 may provide access to at least one subsidy account for subsidized good/service 140, described below. In one embodiment, account information for the subsidy account may be visible on the surface of financial instrument 135, for example, by printing, embossing, etc. In another embodiment, account information for the subsidy account may be encoded in, for example, a magnetic stripe, a computer chip, a machine-readable code, etc.

Financial instrument 135 may be branded to use available payment networks. For example, financial instrument 135 may be branded with the VISA®, MASTERCARD®, or AMERICAN EXPRESS® brand and may use the payment network associated with that brand. In another embodiment, other debit card networks (e.g., Cirrus, Maestro, PLUS) may be used. Other payment networks may be used as necessary and/or desired.

In one embodiment, financial instrument 135 may be a multi-purpose card. For example, in one embodiment, financial instrument 135 may provide access to multiple financial accounts. In another embodiment, financial instrument 135 may further function as an access or identification card. In other embodiments, financial instrument 135 may also be a health insurance card, a membership/rewards card, a library card, a benefits tracking card, etc.

In another embodiment, financial instrument 135 may expire after the passage of a predetermined period of time. In another embodiment, financial instrument 135 may be a single use card. In another embodiment, financial instrument 135 may expire after a predetermined number of uses, etc.

In another embodiment, financial instrument 135 may only be active at certain days, times, etc. For example, in a public transportation subsidy, financial instrument 135 may be active during non-rush hours to encourage the subsidy recipient to use public transportation during those hours.

In another embodiment, financial instrument 135 may only be active when certain events occur. Again in the context of public transportation, for example, financial instrument 135 may only be active on “code red” (high ozone) days, natural disasters (snow/ice storms, hurricanes, earthquakes, etc.), after-hours required work (e.g., an individual who carpools or uses other transportation is subsidized to use private transportation, such as a taxi, if public transportation is not available in emergency situations, when the individual has to work beyond the hours of operation of public transportation, etc), to encourage the use of public transportation. In one embodiment, a public transportation subsidy, private transportation subsidy, etc. may be activated.

In another embodiment, financial instrument may also be deactivated during certain events. For example, in the context of public transportation, if severe weather closes the subsidy recipient's place of business, the subsidy recipient may not be able to use the subsidy that day.

In one embodiment, the above devices may be enabled to communicate wirelessly by, for example, radio frequency (RF), infra red (IR), near field communication, optical code or character recognition, etc. In another embodiment, financial instrument 135 may be read by swiping or dipping a magnetic stripe. In still another embodiment, a biometric device may be used alone or in conjunction with other communications methods.

In one embodiment, financial instrument 135 may be provided to a single subsidy recipient 130 by subsidy host 120. In another embodiment, financial instrument 135 may be provided to subsidy provider 110 by subsidy host 120, and then provided to subsidy recipient 130. In still another embodiment, financial instrument 135 may already be in the possession of subsidy recipient 130.

In one embodiment, financial instrument 135 may be provided to each member of a group of subsidy recipients 130. For example, subsidy provider 110 may set up a subsidy fund that may be accessed by a group of subsidy recipients 130.

In one embodiment, financial instrument 135 may be linked to at least one separate transaction account. For example, financial instrument 135 may be replenished with funds from an employee's checking account, savings account, debit account, credit account, etc.

In another embodiment, financial instrument 135 may provide a hierarchal access to the accounts linked thereto. In one embodiment, the hierarchy may be established by subsidy host 120. In another embodiment, the hierarchy may be established by subsidy provider 110. In still another embodiment, the hierarchy may be established by subsidy recipient 130.

Subsidized good/service 140 may be any good or service for which a third party, such as subsidy provider 110, may provide a subsidy. In one embodiment, subsidized good/service 140 may be related to commuting, including travel and transportation. For example, in one embodiment, subsidized good/service 140 may be a public transit system (e.g., bus, rail, ferry, light rail, subway, etc.). In another embodiment, subsidized good/service may be a private transportation system (e.g., a taxi, limousine service, etc.). In still another embodiment, subsidized good/service 140 may be a parking allowance. In another embodiment, subsidized good/service 140 may be a toll allowance.

The subsidy may be monetary (e.g., a dollar amount) or it may be based on a quantifiable transaction (e.g., a number of bus rides, a number of turnstile turns, a number of units of food, etc.). In still another embodiment, the subsidy may be based on a unit of time (e.g., annually, monthly, weekly, hourly, etc.). In one embodiment, the subsidy may be based on a combination of any of the above, for example, a number of bus rides in a month.

Subsidized good/service 140 may also include subsidies that are not related to transit or commuting. For example, subsidized good/service 140 may be a housing subsidy, such as a rent or housing allowance. In another embodiment, subsidized good/service 140 may be a food subsidy. In another embodiment, subsidized good/service 140 may be a utility subsidy, such as a heating, a telephone, a cellular phone, an Internet service provider, etc. subsidy. In still another embodiment, subsidized good/service 140 may be a health-related subsidy, such as a medical, a dental, a vision, immunization, etc. subsidy. In another embodiment, subsidized good/service 140 may be an educational (e.g., tuition) subsidy. In another embodiment, subsidized good/service 140 may be a child care subsidy, foster care subsidy, etc. In another embodiment, subsidized good/service 140 may be an elder care subsidy. In another embodiment, it may be a temporary assistance for needy family, or TANF subsidy. Other subsidized goods/services may be included as necessary and/or desired.

In one embodiment, the subsidized good/service may include goods or services that can be funded with pre-tax dollars.

In one embodiment, the subsidy funds and/or subsidy account remain the property of subsidy provider 110. As such, and as will be discussed below, the employer may place limitations or restrictions on the use of the subsidy funds, recall subsidy funds from the subsidy account to the subsidy provider 110's account, etc.

In one embodiment, the subsidy funds may be commingled with the subsidy recipient's funds in a single account. The subsidy-eligible transactions may be tracked based on the type of POS device at which the transaction was conducted (e.g., RFID at a transit station versus swiping the card at a store), by the MCC, etc.

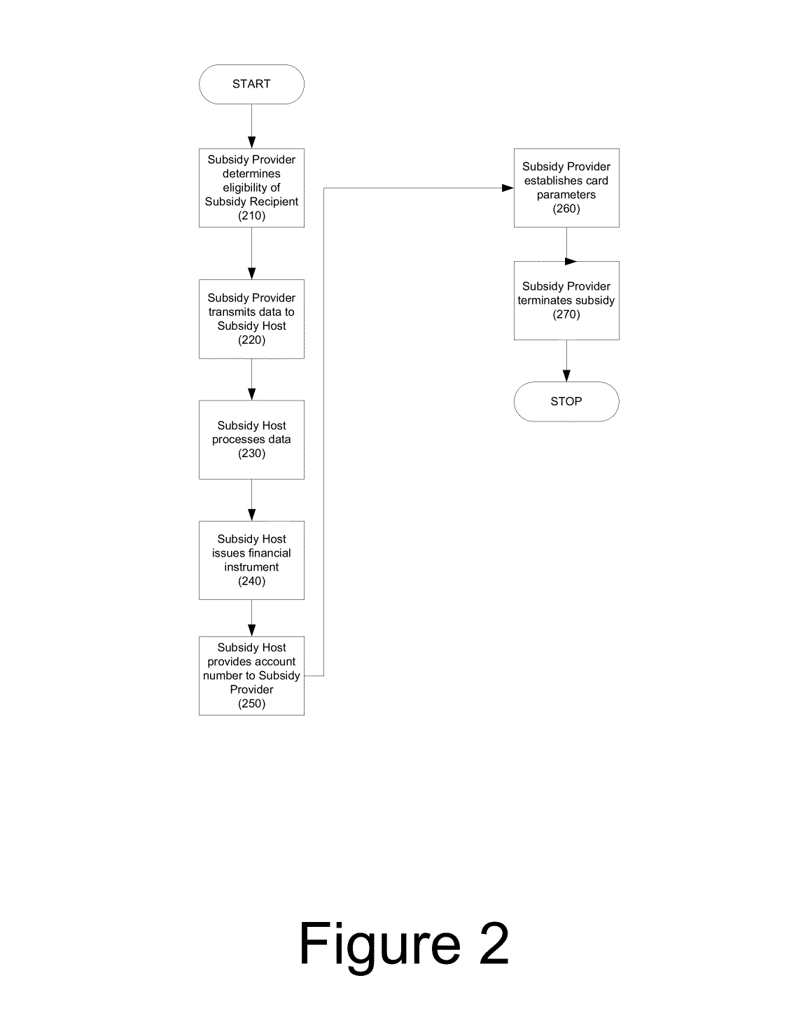

Referring to FIG. 2, a method for managing and using a third party subsidy account according to one embodiment is illustrated. In step 210, the subsidy provider may determine whether the subsidy recipient is eligible for the subsidy. In one embodiment, where the subsidy recipient is an employee receiving a commuting subsidy from an employer, this may include verifying an employment of the employee; verifying the employee's status, verifying that the employee's home of record is a certain distance from the place of work, verifying the employee's income, etc. The eligibility requirements may vary depending on the type of subsidy, amount of subsidy, etc.

In another embodiment, where the subsidy provider is not an employer, the subsidy provider may verify a subsidy recipient's address, income, etc.

In addition, in one embodiment, the need of the subsidy recipient, may be verified. In another embodiment, any past history of the subsidy recipient receiving the subsidy may be analyzed.

In step 220, the subsidy provider may provide a host with data for a subsidy account. In one embodiment, where the subsidy provider is an employer and the subsidy recipient is an employee, the data may include the name and/or identification of at least one employee for a subsidy account, the type of subsidy, the amount of the subsidy (i.e., monetary, quantity, etc.), the period for the subsidy, the method of replenishment, whether the account is for an individual or whether it is for a group, etc.

In one embodiment, the request may provide additional information regarding the account. For example, the subsidy provider may place limitations or restrictions (e.g., geographical, dates of use, times of use, etc.) on the use of the subsidy account. In another embodiment, the request may provide reporting thresholds (i.e., to detect potentially fraudulent transactions) so that an alert may be sent if the use exceeds a certain velocity, monetary amount, etc.

In one embodiment, the request may include information that may be provided by the subsidy recipient. For example, if the subsidy account is to be linked to another of the subsidy recipient's accounts (such as a credit card account, savings account, checking account, etc.), the subsidy recipient may provide information for that account information.

The subsidy recipient may also specify notification preferences for the subsidy account. For example, the subsidy recipient may request to be notified when a subsidy account balance falls below a certain amount. The subsidy recipient may request to be notified with the subsidy account balance periodically (daily, weekly, bi-weekly, etc.). The subsidy recipient may request to be notified when the subsidy account balance is above or below a certain threshold periodically. For example, it may be useful to know that a certain amount of subsidy remains as the end of the subsidy period approaches so that the subsidy is not lost. The subsidy recipient may request to be notified whenever the subsidy is replenished. Other notification may be used as necessary and/or desired.

In one embodiment, the notifications may be sent by any suitable means, including, for example, email, SMS/MMS (text), instant message, voice, facsimile, mail, social networking website, etc. In another embodiment, the notifications may be provided on an online subsidy account manager webpage. Other notification techniques may be used as necessary and/or desired.

In step 230, the subsidy host receives and processes the data. In one embodiment, the host may establish a new account for the subsidy recipient as requested. In one embodiment, where the subsidy recipient is an employee, this may include verifying the identity of the employee, verifying the employee's employment, verifying eligibility for the subsidy, verifying additional account information; need, history, etc.

In step 240, the subsidy host may issue a financial instrument. In one embodiment, the host may issue the financial instrument to the subsidy provider. In another embodiment, the host may issue the financial instrument to the subsidy recipient.

In one embodiment, the financial instrument may be any suitable instrument, for example, a credit card, a stored value card, a prepaid card, an on-card stored value account, a debit card, a private label card, a smart card, a fob, a sticker, a token, an electronic device, a memory card, a cell phone, a PDA, etc.

In one embodiment, the subsidy host may issue a prepaid card with the amount of the subsidy. In one embodiment, the prepaid card may be labeled with the subsidy recipient's name. In one embodiment, the subsidy remains the property of the subsidy provider.

In step 250, the subsidy host may provide the subsidy account number to the subsidy provider.

In step 260, if not done so already, the subsidy provider may establish a subsidy type, value, the method and timing of refresh, etc. The subsidy provider may also modify the parameters of the account, cancel previously unused subsidies, modify account demographics, etc. as necessary and/or desired.

In one embodiment, the subsidy provider may provide reporting of the use of the subsidy. For example, the subsidy provider may generate a report to substantiate a grant (e.g., from a governmental agency), for internal record keeping; for planning, for subsidy provider statements, etc.

In one embodiment, the subsidy provider may send this information to the subsidy host as an electronic file.

In step 270, if and when appropriate, the subsidy provider may request that the subsidy be terminated.

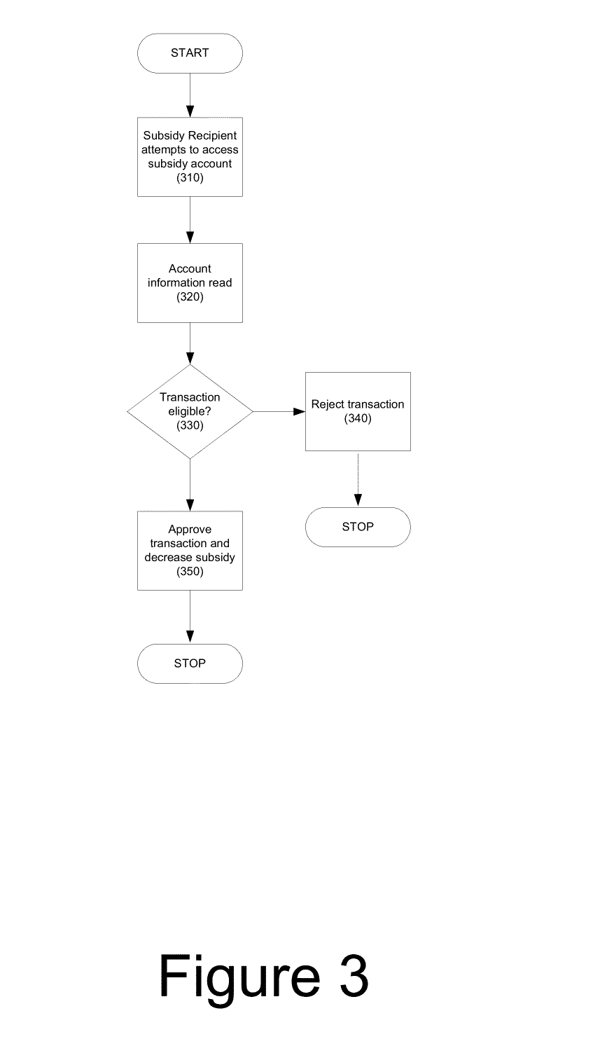

Referring to FIG. 3, a method for using the subsidy is provided. In step 310, the subsidy recipient attempts to use the financial instrument to pay for a transaction.

In one embodiment, the subsidy recipient may present the financial instrument to a point of sale device, a kiosk, etc. In another embodiment, the subsidy recipient may present the financial instrument to a salesperson. In another embodiment, the subsidy recipient may enter account information for the financial instrument on-line.

In step 320, the account information is retrieved from the financial instrument. In one embodiment, this may be read at a point of sale device by, for example, swiping a magnetic stripe, presenting the card to a RF reader, etc.

In step 330, the system determines whether or not the transaction is eligible for the subsidy. In one embodiment, the host may determine eligibility. In another embodiment, the point of sale device may determine eligibility.

In one embodiment, the merchant category code, or MCC, may be used to determine whether the transaction is likely eligible. For example, if the subsidy is provided for commuting services, a MCC associated with “Commuter Transportation” or “Passenger Railways” may be used to determine that a transaction is likely eligible.

In another embodiment, a MCC for a merchant that is likely to be a vendor of subsidy-eligible materials may be used. For example, if convenience stores in a certain area are known to sell public transportation fare, the MCC for “Miscellaneous Food Stores—Convenience Stores and Specialty Markets” may be accepted.

In another embodiment, a merchant identifier may be used. For example, a merchant may be assigned a particular identification code, number, etc. The merchant identifier may be assigned to an overall merchant (e.g., Wal-Mart may have its own merchant identifier), to individual stores (e.g., Wal-Mart store #123 may have its own merchant identifier), etc. In one embodiment, a store may be assigned merchant identifiers for both the chain (e.g., Wal-Mart) and the specific store (e.g., Wal-Mart store #123). Thus, use of the subsidy may be restricted to a particular merchant, to an individual store, etc.

In another embodiment, the name of the merchant, the region that the transaction was conducted in, region (city, state, country, zip code, etc.), transaction association type, etc. may be used to identify the transaction as eligible or ineligible.

In one embodiment, geographical limitations or restrictions may be placed on the use of the subsidy. For example, if a subsidy recipient resides in New York City, an attempt to use the subsidy in California may be rejected.

In one embodiment, a subsidy recipient may request to have an exemption from a geographical limitation or restriction if the subsidy recipient is to be traveling or stationed in an area that is not the area of record.

In one embodiment, day and/or time limitations or restrictions may be placed on the use of the subsidy. For example, if the subsidy is a weekday commuting subsidy, and the subsidy recipient attempts to use the subsidy on a weekend, the attempt may be rejected.

In another embodiment, the amount of the subsidy that may be used within a certain time period may be limited or restricted. For example, if the subsidy is a commuting subsidy, only a certain percentage of the subsidy, or number of transit rides, may be used per workday, per 24 hour period, per week, etc. Any suitable period may be used. In one embodiment, more than one review per subsidy period may be used.

Any suitable use of merchant identifiers, MCCs, geographical limitations or restrictions, time limitations or restrictions, etc. may be used as necessary and/or desired.

In one embodiment, a request to use the subsidy may be rejected if the amount per certain time period is violated. In another embodiment, the subsidy provider, subsidy recipient, and/or subsidy host may be notified as this may indicate a fraudulent use of the subsidy.

In one embodiment, the transaction may not be found to be eligible for the subsidy if the subsidy has been exhausted.

In one embodiment, the subsidy recipient may be able to make a claim against the subsidy if the subsidy recipient can provide justification for a rejected attempt.

In step 340, if the transaction is not eligible, the charge to the subsidy may be declined. The transaction may still be processed by, for example, using an account that is linked to the subsidy account, using a separate account, etc. In one embodiment, the subsidy recipient may cancel the transaction if the subsidy is declined.

If, in step 350, if the transaction is eligible, the transaction is processed and the value in the subsidy account is decreased. In one embodiment, the subsidy may be decreased by the amount of the transaction. In another embodiment, the subsidy may be decreased by a portion of the amount of the transaction. In another embodiment, the subsidy account may be decreased by a number, for example, the number of rides remaining in the subsidy account.

Although the description above was in the context of a subsidy involving several transactions per subsidy period, it should be recognized that, in one embodiment, only one transaction may occur in that subsidy period. For example, the subsidy recipient may conduct a transaction for a monthly transit pass once per subsidy period. In another embodiment, the subsidy recipient may conduct a transaction for a utility once per subsidy period.

Further, although the discussion above is in the context of a subsidy provided to an individual subsidy recipient, in one embodiment, an aggregated subsidy may be provided for more than one subsidy recipient. For example, a school district may receive a subsidy for providing school lunches. The subsidy may be provided as a number of lunches, a value for the lunches, etc. When a school lunch is provided to a student, the number (or value) of remaining subsidized lunches is deducted from the subsidy.

It should further be recognized that the subsidy recipient need not be directly involved in the subsidy transaction. For example, the subsidy recipient may provide a utility company with subsidy information, and the utility company may directly charge the subsidy each month, and charge the subsidy recipient for any balance.

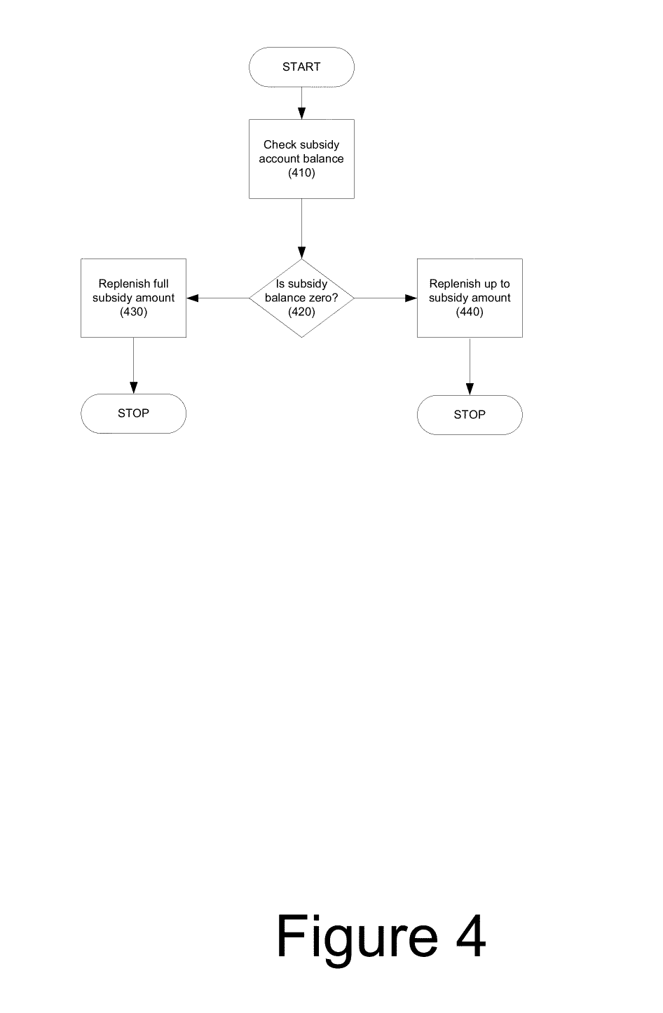

Referring to FIG. 4, a method of subsidy replenishment is provided. Although the description below involves replenishment based on a time-based expiration of subsidy benefits (e.g., at the end of a week, month, year, etc.), the subsidy may expire in different ways. In one embodiment, the subsidy may expire upon reaching (or using) a certain monetary amount. For example, the subsidy may expire when the subsidy recipient spends $100 on food.

In another embodiment, the subsidy may expire when all units of the subsidy are used. For example, the subsidy may expire when a certain number of gallons of milk are purchased. Another example is that the subsidy may expire when three rides are taken on public transit. The value of the underlying transactions may be irrelevant to the expiration of the subsidy.

In one embodiment, the value of the subsidized item may be negotiated by the subsidy provider and the vendor of the subsidized item. For example, the subsidy provider may negotiate a discount for the purchase of food, transit passes, utilities, etc.

In step 410, at the end of the subsidy period, or upon the expiration of the subsidy (e.g., value, usage, etc.), the remaining subsidy balance is determined.

In step 420, if the subsidy balance is zero, in step 430, the full subsidy amount is replenished. For example, if the monthly subsidy amount is $100, a $100 value will be added to the subsidy account As another example, if the full subsidy amount is 10 transit rides per period, then 10 transit rides will be added to the subsidy account.

In step 420, if a subsidy balance remains, then the subsidy balance up to the subsidy amount is replenished in step 440. In one embodiment, this may be done by adding the difference between the periodic subsidy amount and the subsidy account balance to the subsidy account. For example, if the monthly subsidy amount is $100, and $20 remains in the subsidy account, then $80 will be added to the subsidy account, resulting in a $100 subsidy account balance. Similarly, in another example, if the monthly subsidy amount is 10 transit rides, and 2 transit rides remain, then 8 transit rides are added to the subsidy account.

In another embodiment, the subsidy balance may be transferred from the subsidy account to the subsidy provider's account, thereby leaving a zero balance on the subsidy account, and then the full subsidy amount may be added to the subsidy account. For example, if the monthly subsidy account is $100 and $20 remains in the subsidy account, the $20 will be transferred back to the subsidy provider's account, and then $100 will be added to the subsidy account, resulting in a $100 subsidy account balance. Similarly, in another example, if the monthly subsidy amount is 10 transit rides, and 2 transit rides remain, the 2 transit rides will be transferred back to the subsidy provider's account, and 10 transit rides will be added to the subsidy account. This will result in 10 transit rides being in the subsidy account.

In one embodiment, the amount in the subsidy account will not exceed the periodic subsidy amount.

In one embodiment, the subsidy amount may vary. For example, the subsidy amount may vary based on, for example, subsidy recipient's need, seniority, status, etc. In one embodiment, if the subsidy is a commuting subsidy, factors such as the necessity for the employee to work from an office rather than telecommute, employee transit distance, number of days the employee commutes, the cost of commuting, the type of public transportation available, etc.

In another embodiment, the subsidy amount may change from period to period. For example, the amount of subsidy may vary depending on the number of days (or workdays) in a month. Thus, for an employee commuting subsidy, a month with fewer workdays may have a lesser subsidy amount than a month with a greater number of workdays.

In another example, a subsidy amount may be decreased if an employee is known to not be eligible for the subsidy due to vacation, travel, etc.

In one embodiment, the use of the subsidy may be reviewed within the subsidy period and adjusted accordingly. For example, if the subsidy recipient has not used the subsidy in the first half of a month, half of the subsidy amount may be transferred back to the subsidy provider's account.

Other occurrences that may warrant subsidy adjustment include, for example, vacation, holidays, inclement weather days, etc.

The system may provide the subsidy host, the subsidy provider and/or the subsidy recipient the ability to manage the subsidy accounts. In one embodiment, the subsidy host may have the ability to establish new accounts for the employer, modify subsidy types, amounts, etc., to link the subsidy recipient's accounts to the subsidy account, to add additional accounts to the financial instrument, to set up limitations or restrictions on the use of the subsidy account, to enter the subsidy recipient's geographical information, etc.

The subsidy provider may be provided with an interface for managing the subsidy accounts. In one embodiment, the interface may be a web-based interface. The employer may be able to request a financial interface for an employee, enter the subsidy recipient's information, establish a subsidy type, amount, replenishment method, enter limitations or restrictions on the use of the subsidy account, etc.

The subsidy provider may be able to modify subsidy amounts, terminate subsidies, request reports on subsidy usage (e.g., for tax purposes, for monitoring effectiveness, to illustrate concern for the environment, etc.), etc.

The subsidy recipient may be provided with an interface for managing its subsidy account. In one embodiment, the interface may be a web-based interface. In another embodiment, the interface may be a mobile web interface. In still another embodiment, the interface may be a mobile application. In another embodiment, the interface may be a voice-based or touchtone based response system. In still another embodiment, the interface may be a SMS/text based response system.

In one embodiment, the subsidy recipient may set up notifications for subsidy usage, amount remaining, number of days remaining in subsidy period, verification that a subsidy amount has been replenished, etc. The subsidy recipient may further link at least one financial transaction account to the subsidy account. In one embodiment, the subsidy recipient may establish a hierarchical ranking for accessing the subsidy and one or more financial transaction accounts.

The subsidy recipient may further enter information regarding time spent outside of the home area. This information may be used to account for any geographical limitations or restrictions so that the subsidy recipient can still use the subsidy for eligible transactions when outside of the home area.

In one embodiment, the subsidy recipient may be able to request emergency trips, amounts over the subsidy, etc.

In one embodiment, the subsidy recipient may be provided with notifications on a mobile phone, smart phone, PDA, laptop, tablet computer, desktop computer, etc. These notifications may be text-based, graphical, audible, any combinations of these, etc. For example, a thermometer-like graphical representation of the amount of subsidy remaining may be provided, with the “mercury” indicating the amount of subsidy used (or, alternatively, remaining). The subsidy recipient may also be provided with the number of days, units, or other subsidy measurement of the subsidy used (or remaining) in the subsidy period.

In another embodiment, an icon may be displayed on the subsidy recipient's mobile device as necessary and/or desired.

In one embodiment, the subsidy recipient may be informed of preferred vendors for using the subsidy. These preferred vendors may have a negotiated discounted rate for the subsidy items.

In one embodiment, the financial instrument may be provided with a display that displays information regarding the subsidy (e.g., the amount of the subsidy remaining, subsidy period information, etc.).

In one embodiment, the subsidy recipient may be able to customize the information sent to and/or displayed as necessary and/or desired.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the Microsoft Windows™ 7 operating system, the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine A user interface may be in the form of a dialogue screen, for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method of using a third party subsidy account, comprising:
using at least one computer processor, funding a subsidy account for a subsidy recipient in a subsidy program with first subsidy funds having a first subsidy expiration;
receiving, from one of a plurality of providers of a subsidized good or service within an open loop payment system, a payment request for a transaction with the subsidy recipient;
using the at least one computer processor, verifying that the transaction is for an eligible subsidized good or service;
using the at least one computer processor, debiting the subsidy account for the verified transaction;
using the at least one computer processor, de-funding the subsidy account at the first subsidy expiration; and
using the at least one computer processor, funding the subsidy account with second subsidy funds having a second subsidy expiration.

2. The method of claim 1, wherein the subsidy funds comprises a dollar amount.

3. The method of claim 1, wherein the subsidy funds comprises a number of an item.

4. The method of claim 1, wherein the subsidy expiration is based on a value of the subsidy.

5. The method of claim 1, wherein the subsidy expiration is based on a time period.

6. The method of claim 1, wherein the subsidy funds are from one of the plurality of providers of the subsidized good or service.

7. The method of claim 6, wherein the step of de-funding the subsidy account comprises transferring subsidy funds remaining in the subsidy account to an account of the subsidy provider.

8. The method of claim 1, further comprising:
using the computer processor, monitoring a use of the subsidy funds; and
using the computer processor, providing a notification regarding the subsidy funds to the subsidy recipient.

9. The method of claim 8, wherein the notification includes a balance of the subsidy funds.

10. The method of claim 8, wherein the notification includes an expiration for the subsidy funds.

11. The method of claim 8, wherein the notification is one of a text-based notification, a graphical notification and an audible notification.

12. The method of claim 1, further comprising:
limiting a use of the subsidy account.

13. The method of claim 12, wherein the use is limited by at least one of a merchant category code, a merchant identifier, a geographic restriction, a time/date restriction, and a value restriction.

14-29. (canceled)

30. The method of claim 1, wherein the plurality of providers of the subsidized good or service comprises at least one public provider and at least one private provider.

31. The method of claim 1, wherein the plurality of providers of the subsidized good or service all provide the same subsidized good or service.

32. The method of claim 1, wherein the subsidized good or service comprises a utility subsidy.

33. The method of claim 1, wherein the subsidized good or service comprises a communication subsidy.

34. The method of claim 1, wherein the subsidized good or service comprises an education subsidy.

35. The method of claim 1, wherein the subsidized good or service comprises one of a child care subsidy and an elder care subsidy.

36. The method of claim 1, wherein the subsidized good or service comprises a housing subsidy.

37. The method of claim 1, wherein the subsidized good or service comprises a healthcare subsidy.

38. (canceled)

39. The method of claim 1, wherein the step of verifying that the transaction is for an eligible subsidized good or service comprises:
receiving, from the one of the plurality of providers of a subsidized good or service, a merchant identifier; and
the at least one computer processor verifying that the merchant identifier is for a provider of the eligible good or service.

40. The method of claim 39, wherein the merchant identifier is a merchant category code.

41. The method of claim 39, wherein the merchant identifier is a provider name.

42. The method of claim 39, wherein the merchant identifier is a provider location.

43. The method of claim 39, wherein the merchant identifier is a description of goods or services provided by the provider.

44. The method of claim 1, wherein the step of verifying that the transaction is for an eligible subsidized good or service comprises:
receiving, from the one of the plurality of providers of a subsidized good or service, at least one transaction detail for the transaction to be verified; and
the at least one computer processor verifying that the at least one transaction detail is for an eligible good or service.

45. The method of claim 44, wherein the at least one transaction detail comprises a time of the transaction.

46. The method of claim 44, wherein the at least one transaction detail comprises a location of the transaction.

47. The method of claim 44, wherein the at least one transaction detail comprises an amount of the transaction.
